(19) United States
(12) Patent Application Publication
(10) Pub. No.: US 2021/0142128 A1
(43) Pub. Date: May 13, 2021

(54) Process that scans a permanent image that is on apparel in order to activate and receive a meaningful audio/visual message.

(71) Applicants: Shawn Roger Bergstrand, Bismarck, ND (US); Nancy Jane Bergstrand, Maple Grove, ND (US)

(72) Inventors: Shawn Roger Bergstrand, Bismarck, ND (US); Nancy Jane Bergstrand, Maple Grove, ND (US)

(21) Appl. No.: 16/933,903

(22) Filed: Jul. 20, 2020

Related U.S. Application Data
(60) Provisional application No. 62/876,312, filed on Jul. 19, 2019.

(51) Int. Cl. G06K 9/78; G06F 3/14; G06K 9/20; G06K 9/22

(52) U.S. Cl. CPC G06K 9/78; G06F 3/14; H04N 5/232945; G06K 9/228; G06K 9/2063

(57) ABSTRACT

Disclosed is a process for using an electronic device to scan an image that is permanently attached either by sewing, gluing, stapling, or the like, to a piece of apparel in order to activate a pre-recorded video on the electronic device and deliver a meaningful, positive, motivational, or instructional message.

### SUMMARY

A process that improves the functionality of a mobile web app for electronic devices in that it can scan a permanently attached image that is printed, stitched, glued, or otherwise becomes a permanent part of a piece of apparel, for the purpose of activating a meaningful audio/visual 2D or 3D message to be received on that same mobile device.

The unique function of the new process gives the wearer of apparel a way to access a meaningful message anytime and have it be more engaging for that person. Rather than the message be a written message, it is brought to life for the wearer on their web based mobile electronic device and delivered with audio/visual content.

No augmented reality glasses or additional devices are needed. The process is very user friendly. When the App is activated and the mobile device is placed over the marker, the App immediately begins scanning right after it is opened. No need to press a button or otherwise activate the scanning process. Also, the camera on the mobile electronic device does not need to be in constant contact with the marker image in order to receive the message.

Once scanned, the message is loaded and begins playing and the device can be moved anywhere while the message continues through to the end. The camera is no longer open while the message continues to completion. An open camera creates a visibly unnecessary distraction when it is open in the background.

The process also includes the ability to be able to frequently change the message that the app activates without changing the marker. The message is not dependent on the marker for its content. This process allows the app administrator to choose the message and how often to change it without ever changing the marker.

Multiple marker recognition can also be programmed into the App. Different markers can activate different messages, or different markers can activate the same message.

1. A process that improves the functionality of a mobile web app for electronic devices in that it can scan a permanently attached image that is printed, stitched, glued, or otherwise becomes a permanent part of a piece of apparel, for the purpose of activating a meaningful audio/visual 2D or 3D message to be received on that same mobile device.

1. The process of claim #1, Once scanned, the message is loaded and begins playing and the device can be moved anywhere while the message continues through to the end.

2. The process of claim #1, the camera is no longer open while the message continues to completion.

3. The process of claim #1 also includes the ability to be able to frequently change the message that the app activates without changing the marker and the message is not dependent on the marker for its content because this process allows the app administrator to choose the message and how often to change it without ever changing the marker.

4. The process of claim #1, multiple marker recognition can also be programmed into the App so different markers can activate different messages, or different markers can activate the same message.
